(19) United States
(12) Patent Application Publication
(10) Pub. No.: US 2008/0032087 A1
(43) Pub. Date: Feb. 7, 2008

(54) Insert Sheet for a Passport and a Passport Including Such a Sheet

(75) Inventor: Pascal Marlin, Coulommiers (FR)

Correspondence Address: OLIFF & BERRIDGE, PLC, P.O. BOX 320850, ALEXANDRIA, VA, 22320-4850, US

(73) Assignee: ARJOWIGGINS SECURITY, Issy Les Moulineaux (FR)

(21) Appl. No.: 11/631,300

(22) PCT Filed: Jul. 7, 2005
(86) PCT No.: PCT/FR05/50554

§ 371 Date: Aug. 17, 2007

(30) Foreign Application Priority Data
Jul. 9, 2004 (FR) 04 51495

(51) Int. Cl. B42D 13/00

(52) U.S. Cl. 428/101; 156/226

(57) ABSTRACT

The present invention relates to an insert sheet (5) for inserting between two sheets, at least one of which is secured to or belongs to the cover of a booklet, in particular a cover of a passport, the insert sheet (5) being designed to be folded in a predefined zone (21) along at least one fold line, the insert sheet being characterized by the fact that in the zone (21) it includes weakening means (20) making it more deformable on folding.

The present invention relates to the covers of booklets, and in particular the covers of a passport.

Proposals have been made to integrate radiofrequency identification (RFID) devices in passport covers in order to increase security. An RFID device is housed at least in part in a window in an insert sheet assembled between outer and inner sheets of the passport cover. The insert sheet is relatively thick and makes the cover difficult to fold, such that the passport tends to remain half-open.

In one of its aspects, the invention seeks specifically to make the cover easier to fold without thereby excessively complicating manufacture thereof.

The invention achieves this by proposing a novel insert sheet for inserting between two sheets, at least one of which is secured to or belongs to the cover of a booklet, in particular a passport cover, said insert sheet being designed to be folded in a predefined zone along at least one fold line. The insert sheet may be characterized by the fact that, in the above-specified zone, it includes weakening means making it more deformable on folding.

By way of example, the insert sheet may be inserted between an outer sheet and an inner sheet of a cover or between a preexisting cover and at least one sheet disposed inside the booklet.

By means of the invention, the cover is made easier to fold without manufacture of the cover and/or of the booklet being made much more complex.

In an embodiment of the invention, the weakening means comprise a cut made without removing material. The absence of any material being removed may serve in particular to reduce the appearance of defects in the surface of the cover, and may also make it possible to avoid too great an accumulation in the cut of the glue that is used for assembling the insert sheet with the adjacent sheet, since such accumulated glue could impede the looked-for deformability.

In an embodiment of the invention, the weakening means comprise a slot, with the insert sheet being made with a plurality of slots, for example.

In particular, the weakening means may comprise a succession of slots disposed in a staggered configuration. Such a disposition enables flexibility to be imparted without excessively weakening the sheet.

The slot(s) may extend substantially parallel to the fold line. In a variant and/or in addition, slots may extend transversely to the fold line.

The weakening means may comprise alternating first groups of slots having slots in an even number, e.g. equal to two, and second groups of slots having slots in an odd number, e.g. equal to three.

The slot(s) is/are advantageously through slot(s), and preferably with edges that are substantially touching.

In an embodiment of the invention, the weakening means are set back from the top and bottom edges of the sheet once it has been integrated or fastened to the cover of the booklet. This makes it possible in particular to avoid degrading the appearance of the cover and to avoid creating a tear starter.

In an embodiment of the invention, the sheet includes a window for receiving at least part of an RFID device.

The sheet may present a multilayer structure, having at least one layer of fiber material, in particular paper-making fiber.

By way of example, the thickness of the sheet lies in the range about 1.5 millimeters (mm) to about 0.5 mm.

In another of its aspects, the invention also provides a booklet cover, characterized by the fact that it includes an insert sheet as defined above disposed between an inner sheet and an outer sheet.

By way of example, the inner and outer sheets are stuck to the insert sheet.

As mentioned above, the insert sheet may include a window housing at least part of an RFID device.

In another of its aspects, the invention provides a booklet, in particular a passport, including a cover as defined above.

In another of its aspects, the invention provides a booklet, in particular a passport, including a cover and a set of leaves, together with an insert sheet as defined above stuck between the cover and at least one leaf of the set of leaves.

In another of its aspects, the invention provides a method of manufacturing an insert sheet for inserting between two sheets, at least one of which is secured to or belongs to the cover of a booklet, in particular a passport, in which weakening means are formed in a predefined zone of the insert sheet, the weakening means making the insert sheet easier to fold along a fold line extending in the above-specified zone.

In another of its aspects, the invention provides a method of manufacturing a cover for a booklet, in particular a passport, in which an insert sheet as defined above is assembled between inner and outer sheets.

At least one window may be formed in the insert sheet in order to receive at least part of an RFID device in a defined position relative to the weakening means.

Advantageously, a single cutting tool, e.g. a rotary tool, is used for making both the weakening means and the window.

The weakening means may comprise a plurality of slots.

The invention can be better understood on reading the following detailed description of non-limiting embodiments thereof, and on examining the accompanying drawing, in which:

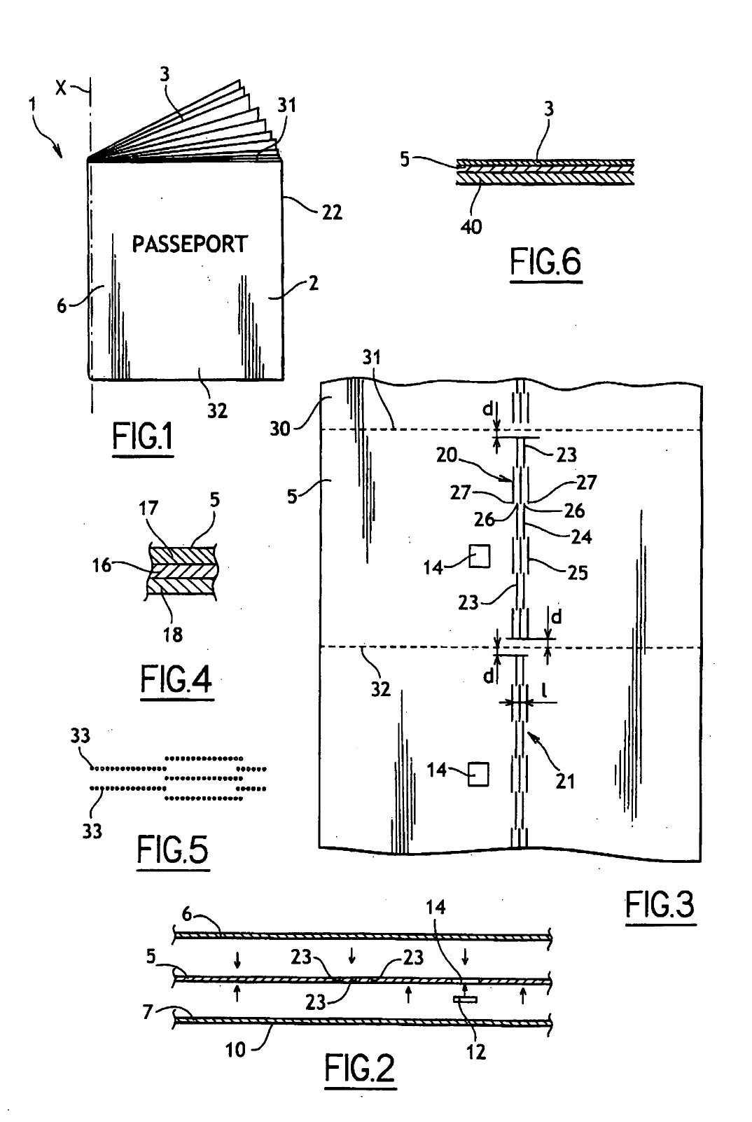

FIG. 1 is a diagrammatic perspective view of a passport having a cover made in accordance with the invention;

FIG. 2 is a diagram showing how the insert sheet is assembled with the inner and outer sheets of the cover;

FIG. 3 shows a strip used for making the insert sheet prior to being cut to the format of the cover;

FIG. 4 is a diagrammatic and fragmentary section view showing the possibility of the insert sheet presenting a multilayer structure;

FIG. 5 shows the possibility of the weakening means comprising series of perforations; and

FIG. 6 shows the possibility of placing the insert sheet between a preexisting cover and a page leaf.

The passport 1 shown in FIG. 1 comprises a cover 2 folded in half substantially along a fold line X so as to protect leaves 3 that are to contain information concerning the holder of the passport and to receive visas.

In the example described, the number of leaves 3 is relatively small, e.g. corresponding to 32 pages, such that the thickness of the passport 2 in the folded state is less than or equal to 10 mm, for example, or even less than or equal to 5 mm, e.g. being about 4 mm.

The cover 2 is of composite structure, comprising an insert sheet 5 situated between outer and inner sheets 6 and 7, the sheets 5, 6, and 7 being assembled together by gluing in the example under consideration.

The free face 10 of the inner sheet 7 can be used for assembling the leaves 3 to the cover 2 of the passport, e.g. by gluing.

In the example under consideration, the cover 2 includes a radiofrequency identification (RFID) device 12 that can enable data to be transferred without contact with a suitable reader, the data contained in the RFID device 12 relating, for example, to the holder of the passport and including information useful for authenticating the passport.

The RFID device 12 may include an integrated antenna, or in a variant the antenna may be made at least in part on the insert sheet 5, and in particular in the thickness thereof.

In the example shown, the insert sheet 5 includes a window 14 which receives at least part of the RFID device 12 so that the cover 2 does not present perceptible extra thickness over the RFID device 12 once the sheets 5, 6, and 7 have been assembled together.

The insert sheet 5 may present a multilayer structure, e.g. having at least one fiber layer 16 sandwiched between two outer layers 17 and 18 serving, for example, to improve the cohesion of the assembly with the outer and inner sheets 6 and 7, and to provide strength to the electrical connections of the RFID device 12, possibly having an antenna present within the insert sheet 5.

The thickness of the insert sheet 5 may be relatively great, e.g. lying in the range about 0.15 mm to 0.5 mm.

The sheets 6 and 7 may also present multilayer structure.

In accordance with an aspect of the invention, in order to make the cover 2 easier to fold along the fold line X, the insert sheet 5 includes weakening means 20 in a predefined zone 21 thereof.

The zone 21 is made over a width l that is sufficient to make the work of assembly easier, given assembly and positioning tolerances in the plane of the sheet 5. During manufacture of the passport, the fold line X is situated inside the zone 21.

In the example described, the zone 21 extends over a width l lying in the range 5 mm to 15 mm, for example being about 8 mm to 10 mm.

In the example shown, the weakening means 20 comprise a plurality of slots 23 each extending substantially parallel to the fold line X once the passport has been made.

These slots 23 may be grouped together as alternating first and second groups 24 and 25 of slots, respectively comprising even numbers and odd numbers of slots disposed side by side, the first group 24 comprising two slots 23 and the second group 25 comprising three slots, for example.

In the example described, the slots 23 are disposed in a staggered configuration.

By way of example, the slots 23 are made by means of a rotary cutter tool that is the same as the tool used for making the windows 14 on a strip 30 of length corresponding to several times the length of the cover 2, the strip 30 subsequently being cut up along lines of cut 31 and 32 that are spaced apart at a distance corresponding substantially to the height of the cover 2 of the final passport.

Advantageously, and as shown, the weakening means 20 start at a non-zero distance d away from the lines of cut 31 and 32 so as to avoid weakening the cover. Apart from the ends of the slot 23 adjacent to the two lines of cut 31 and 32, the ends 26 of the slots in each first group 24 are situated at substantially the same height as the ends 27 of the slots in each second group 25, as can be seen in FIG. 3.

In the example under consideration, the slots 23 are made using a blade and each slot 23 conserves edges that are substantially touching once it has been made.

It would not go beyond the ambit of the present invention for the slots 23 to constitute non-through score lines, e.g. extending through more than half the thickness of the insert sheet 5.

The invention is not restricted to weakening means 20 in the form of slots 23 obtained by means of blades, and the weakening means 20 could be made, for example, as a series of perforations 33, in particular by using needles placed side by side.

The insert sheet 5 may be perforated by series of perforations each extending for example over a length equivalent to the length of a slot 23, as shown in FIG. 5, for example, and where appropriate with a staggered configuration between series of perforations.

The weakening means may also be made by means of a laser, burning the insert sheet 5 in such a manner as to make slots and/or through holes or blind holes in patterns that are advantageously in a staggered configuration. It is also possible to use a water jet cutter device. In a variant, the insert sheet may also include weakening means comprising recesses or cavities formed during its own manufacture, e.g. by a watermark.

In a variant embodiment, the insert sheet 5 may be glued between a preexisting cover 40 and at least one leaf 3 of a set of leaves, as shown in FIG. 6.

The invention is not restricted to making the cover of a passport, and it is equally applicable to making the covers of other booklets, e.g. passbooks or family record books.

The insert sheet may be assembled directly or indirectly with the inner and outer sheets. By way of example the cover may include more than one insert sheet.

Where appropriate, the weakening means may be made through the inner or outer sheets, e.g. by means of a laser.

The set of leaves 3 may be assembled to the cover by stitching. Under such circumstances, it may be preferable to position the weakening means away from the location of the stitching.

Throughout the description, including in the claims, the term “comprising a” should be understood as being synonymous with “comprising at least one”, unless specified to the contrary.

1. An insert sheet for inserting between two sheets, at least one of which is secured to or belongs to the cover of a booklet, the insert sheet being foldable in a predefined zone along at least one fold line, wherein the zone includes weakening means increasing the deformability on folding.

2. A sheet according to claim 1, being configured to be inserted between inner and outer sheets of the cover.

3. A sheet according to claim 1, being configured for being inserted between a preexisting cover and at least one sheet placed inside the booklet.

4. A sheet according to claim 1, wherein the weakening means comprise at least one cut made without removing material.

5. A sheet according to claim 1 wherein, the weakening means comprise a plurality of slots.

6. A sheet according to claim 5, wherein the plurality of slots comprises a succession of slots disposed in a staggered configuration.

7. A sheet according to claim 5, wherein the slots extend substantially parallel to the fold line.

8. A sheet according to claim 5, wherein the plurality of slots comprise alternating first groups having an even number of slots and second groups having an odd number of slots.

9. A sheet according to claim 8, wherein the even number is equal to two and the odd number is equal to three.

10. A sheet according to claim 4, wherein the at least one cut is a through cut.

11. A sheet according to claim 5, wherein the plurality of slots comprises slots having substantially touching edges.

12. A sheet according to claim 1, wherein the weakening means are set back from the top and bottom edges of the sheet once it has been integrated in or fastened to the cover of the booklet.

13. A sheet according to claim 1, including a window for receiving at least in part a radiofrequency identification device.

14. A sheet according to claim 1, wherein a thickness of the sheet lies in the range about 0.15 mm to about 0.5 mm.

15. A sheet according to claim 1, comprising a multilayer structure.

16. A sheet according to claim 1, comprising at least one sheet of fiber material.

17. A booklet cover, including an insert sheet as defined in claim 1, between an inner sheet and an outer sheet.

18. A cover according to claim 17, wherein the outer and inner sheets are glued to the insert sheet.

19. A passport including a cover as defined in claim 17.

20. A passport comprising a cover, a set of leaves, and an insert sheet as defined in claim 1, glued between the cover and at least one leaf.

21. A method of manufacturing a sheet for inserting between two sheets, at least one of which is secured to or belongs to the cover of a booklet, comprising making weakening means in a predefined zone of the insert sheet, the weakening means making the insert sheet easier to fold along a fold line extending in the zone.

22. A method according to claim 21, wherein at least one window is formed in the insert sheet to receive at least a part of an RFID device in a defined position relative to the weakening means.

23. A method according to claim 22, wherein a single cutter tool, is used both to make the weakening means and the window.

24. A method according to claim 23, wherein the weakening means comprise a plurality of slots.

25. A method of manufacturing a booklet cover, in which an insert sheet as defined in claim 1 is assembled between inner and outer sheets.

26. A booklet cover, comprising an insert sheet assembled by gluing between two other sheets, in which the insert sheet includes a succession of cuts in a staggered configuration made in a fold zone without removing material.

27. An insert sheet for inserting between inner and outer sheets of a booklet cover, the insert sheet being configured to be folded in a predefined zone along at least one fold line wherein the zone includes weakening means making it more deformable on folding.

28. An insert sheet for inserting between two sheets, at least one of which is secured to or belongs to the cover of a booklet, the insert sheet being configured to be folded in a predefined zone along at least one fold line, wherein the zone includes weakening means making it more deformable on folding, the weakening means comprising a cut made without removing material.

29. An insert sheet for inserting between two sheets, at least one of which is secured to or belongs to the cover of a booklet, the insert sheet being configured to be folded in a predefined zone along at least one fold line, wherein the zone includes weakening means making it more deformable on folding, and wherein the insert sheet includes a window for receiving at least in part a radiofrequency identification device.

30. An insert sheet for inserting between two sheets, at least one of which is secured to or belongs to the cover of a booklet, the insert sheet being configured to be folded in a predefined zone along at least one fold line, wherein the zone includes weakening means making it more deformable on folding, wherein a thickness of the insert sheet lies in the range about 0.15 mm to about 0.5 mm.

31. A passport comprising a cover, a set of leaves and an insert sheet designed to be folded in a predefined zone along at least one fold line, wherein the insert sheet comprises in the fold zone weakening means making it more deformable on folding, the insert sheet being glued between the cover and at least one leaf.

32. A passport comprising a cover, a set of leaves and an insert sheet configured to be folded in a predefined zone along at least one fold line, wherein the insert sheet comprises in the fold zone weakening means making it more deformable on folding, the insert sheet being glued between inner and outer sheets of the cover of the passport.
